(19) United States
(12) Patent Application Publication
(10) Pub. No.: US 2019/0003982 A1
(43) Pub. Date: Jan. 3, 2019

(54) Optical Video Measurement System Operable in Multiple Positions

(71) Applicant: The L.S. Starrett Company, Athol, MA (US)

(72) Inventors: Richard Manuel Jimenez Dantes, Laguna Niguel, CA (US); Robert Yates, Newport Beach, CA (US); Mark G. Arenal, Mission Viejo, CA (US)

(21) Appl. No.: 15/640,642

(22) Filed: Jul. 3, 2017

(51) Int. Cl. G01N 21/88; H04N 5/225

(52) U.S. Cl. CPC G01N 21/8851; H04N 5/2251; H04N 5/2256

(57) ABSTRACT

A digital optical video measurement system may include a chassis, a digital imaging system coupled to the chassis, and a light source coupled to the chassis. The light source may be configured to emit light along an optical axis extending in a direction of the digital imaging system. The digital optical video measurement system may also include a table coupled to the chassis. The table may have a first orientation and a second orientation. When the table is in the first orientation, the optical axis may intersect the table. When the table is in the second orientation, the optical axis may be spaced apart from the table.

### FIELD

The present disclosure relates generally to optical video measurement systems and more specifically to optical video measurement systems operable in multiple positions.

### BACKGROUND

Optical metrology (i.e., the science of measurement) may be particularly important in the manufacturing industry. For example, certain manufactured parts may require specific dimensions. Although a design template used in the manufacturing of a part may include exact measurements, the actual dimensions of a manufactured part may deviate. As such, it is important that the actual dimensions of a manufactured part be measured or compared to a design template in order to ensure accuracy and consistency in the manufacturing process.

An optical video imaging platform (sometimes referred to as a comparator) is a device that applies the principles of optics to the inspection of manufactured parts. Generally, in a comparator, a magnified image of a manufactured part (such as a silhouette of the part) may be captured by a camera array and then projected upon a display screen and the dimensions and geometry of the part may be measured against prescribed limits. Generally, an optical comparator system includes one or more light sources, a support for the manufactured part, optics, and a display screen. The dimensions of the manufactured part may be compared with the dimensions of a design template or to a calibrated linear or measurement standard to identify any inaccuracies and/or defects in the manufacturing of the part.

### BRIEF DESCRIPTION OF THE DRAWINGS

Features and advantages of the claimed subject matter will be apparent from the following detailed description of embodiments consistent therewith, which description should be considered with reference to the accompanying drawings, wherein:

FIG. 1 is a schematic diagram of a digital optical video measurement system in a first position, consistent with embodiments of the present disclosure.

FIG. 2 is a schematic diagram of the digital optical video measurement system of FIG. 1 in a second position, consistent with embodiments of the present disclosure.

FIG. 3 is a plan view of a digital optical video measurement system in a first position, consistent with embodiments of the present disclosure.

FIG. 4 is a plan view of the digital optical video measurement system of FIG. 3 in a second position, consistent with embodiments of the present disclosure.

FIG. 5 is a perspective view of the digital optical video measurement system of FIG. 3 in the first position, consistent with embodiments of the present disclosure.

FIG. 6 is another perspective view of the digital optical video measurement system of FIG. 3 in the first position, consistent with embodiments of the present disclosure.

FIG. 7 is another perspective view of the digital optical video measurement system of FIG. 3 in the second position, consistent with embodiments of the present disclosure.

FIG. 8 is a perspective view of the digital optical video measurement system of FIG. 3 having a table that is decoupled from the digital optical video measurement system, consistent with embodiments of the present disclosure.

FIG. 9 is a perspective view of a chassis for the digital optical video measurement system of FIG. 3 having a light source and a digital imaging system, consistent with embodiments of the present disclosure.

FIG. 10 is another perspective view of a chassis for the digital optical video measurement system of FIG. 3 having a light source and a digital imaging system, consistent with embodiments of the present disclosure.

### DETAILED DESCRIPTION

The present disclosure is generally directed to a digital optical video measurement system for comparing a manufactured part against a digital representation of the manufactured part or to a calibrated measurement standard related to the part. The measurement system may include a chassis, a light source, and a digital imaging system. The light source and the digital imaging system may be coupled to the chassis such that the light source is positioned opposite the digital imaging system. As such, light generated by the light source is emitted in a direction of the digital imaging system. A table may be positioned between the light source and the digital imaging system such that, when a manufactured part is positioned on the table, at least a portion of the generated light impinges on (e.g., is incident on) the manufactured part.

In operation, the measurement system may be capable of transitioning between a first position (e.g., a vertical position) and a second position (e.g., a horizontal position) by pivoting about a pivot point. Additionally, or alternatively, the table may transition between a first orientation and a second orientation. In some instances, the table may transition between the first orientation and the second orientation in response to the measurement system transitioning between the first and second positions. Therefore, the measurement system may generally be described as having at least two positions in which the measurement system is operable.

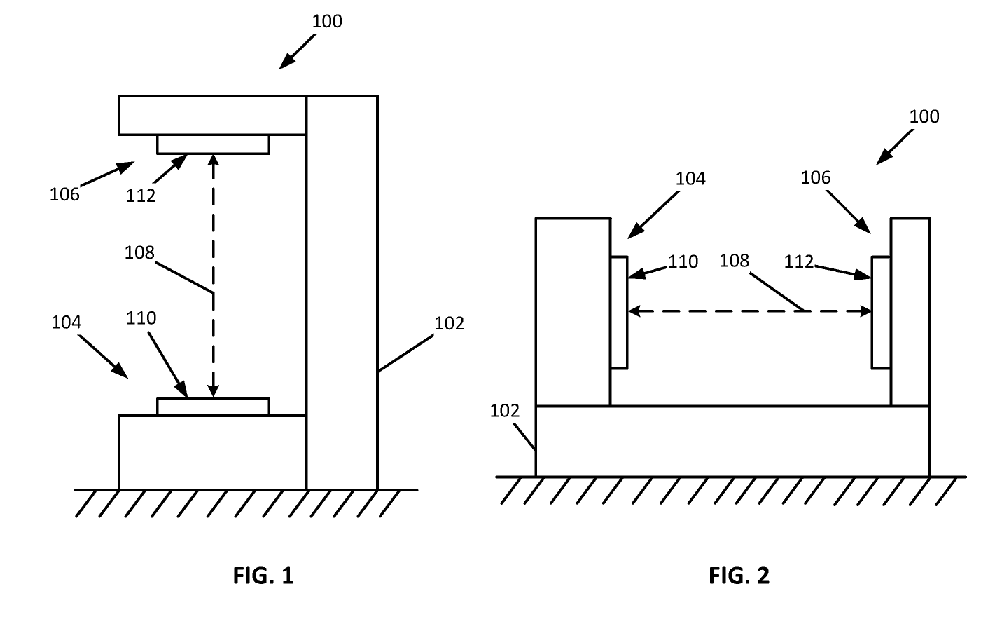

FIG. 1 shows a schematic representation of a digital optical video measurement system 100 in a first position (e.g., a vertical position) and FIG. 2 shows a schematic representation of the measurement system 100 in a second position (e.g., a horizontal position). As shown, the measurement system 100 includes a chassis 102, a light source 104, and a digital imaging system 106. The light source 104 is coupled to the chassis 102 at a location opposite the digital imaging system 106. As such, the light emitted from the light source 104 travels along an optical axis 108 that extends from an emitting surface 110 of the light source 104 to a receiving surface 112 of the digital imaging system 106. In other words, light emitted from the light source 104 travels along the optical axis 108 in a direction of the digital imaging system 106.

As shown, the light source 104 and the digital imaging system 106 are coupled to the chassis 102 such that the emitting surface 110 of the light source 104 faces (e.g., is opposite) the receiving surface 112 of the digital imaging system 106. In some instances, the light source 104 and the digital imaging system 106 may each be coupled to the chassis 102 such that the light source 104 and the digital imaging system 106 extend from the chassis 102. In other instances, one or more of the light source 104 and/or the digital imaging system 106 may be positioned at least partially within a volume defined by the chassis 102. Therefore, the chassis 102 may have, for example, an “L-shape,” a “U-shape,” or any other suitable shape.

The light source 104 is configured to emit light. For example, the light source 104 may include any one or more of an incandescent light source (e.g., a halogen lamp, an incandescent light bulb, etc.), an electric discharge light source (e.g., a fluorescent lamp, a metal halide lamp, etc.), one or more light emitting diodes (LEDs), and/or any other suitable light source. The digital imaging system 106 may include any device configured to capture an image (or a plurality of images). For example, the digital imaging system 106 may be a digital camera, a digital video camera, and/or any other suitable image-capturing device capable of being used to produce one or more digital images.

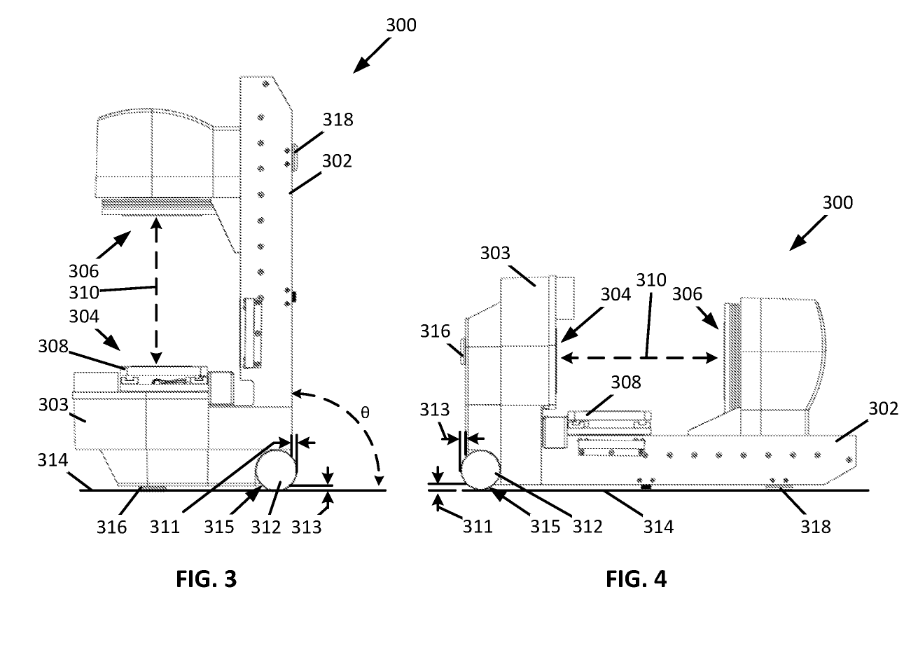

FIG. 3 shows a digital optical video measurement system 300 in a first position (e.g., a vertical position) and FIG. 4 shows the measurement system 300 in a second position (e.g., a horizontal position). The measurement system 300 may be an example of the measurement system 100 of FIGS. 1 and 2.

In the illustrated embodiment, the measurement system 300 includes a chassis 302, a light source 304, a digital imaging system 306, and a table 308. The light source 304, the digital imaging system 306, and/or the table 308 may be coupled to the chassis 302. The chassis 302 may be at least partially enclosed by an enclosure 303. The light source 304 is positioned opposite the digital imaging system 306 such that light emitted from the light source 304 travels along an optical axis 310 in a direction of the digital imaging system 306. The table 308 is positioned between the light source 304 and the digital imaging system 306 such that, when an object (e.g., a part to be measured) is positioned (e.g., rests) on the table 308, at least a portion of the light emitted from the light source 304 impinges on (e.g., is incident on) the object. The orientation of the table 308 may be changed in response to the measurement system 300 transitioning from a first position (as shown to in FIG. 3) to a second position (as shown in FIG. 4).

When transitioning between the first and second positions, the measurement system 300 may be pivoted on a rocker 312 (e.g., a fulcrum). As shown, the rocker 312 is coupled to the chassis 302 such that the chassis 302 pivots about the rocker 312 between the first and second positions. When pivoting on the rocker 312 the chassis 302 rotates through a rotation angle θ. The rotation angle θ may measure approximately 90°. For example, the rotation angle θ may measure in a range of 85° to 95°. As shown, when the measurement system 300 rotates through a rotation angle θ of 90°, the optical axis 310 is substantially parallel with a surface 314 (e.g., a floor, a table, or any other surface).

In the illustrated embodiment, at least a portion of the rocker 312 extends beyond the enclosure 303 by first and second extension distances 311 and 313 such that the rocker 312 engages (e.g., contacts) the surface 314. Therefore, the rocker 312 may generally be described as being coupled to the measurement system 300 (e.g., coupled to the chassis 302) such that a peripheral surface 315 of the rocker 312 corresponds to a bottom most portion of the measurement system 300 (e.g., the portion of the measurement system 300 engaging the surface 314). In some instances, the first extension distance 311 may measure equal to the second extension distance 313. In other instances, a measure of the first extension distance 311 may be greater than (or less than) a measure of the second extension distance 313.

As shown, when the measurement system 300 is in the first position, the measurement system 300 is supported on the surface 314 using one or more first feet 316 and the rocker 312 and, when the measurement system 300 is in the second position, the measurement system 300 is supported on the surface 314 using one or more second feet 318 and the rocker 312. One or more of the rocker 312, the one or more first feet 316, and/or the one or more second feet 318 may be adjustable for the purposes of leveling the measurement system 300 on the surface 314. The rocker 312, the one or more first feet 316, and/or the one or more second feet 318 may include and/or be formed from one or more of a rubber (e.g., polybutadiene rubber, butyl rubber, styrene-butadiene rubber, silicone rubber, and/or any other suitable rubber), a metal (e.g., a stainless steel alloy, an aluminum alloy, a titanium alloy, and/or any other suitable metal or metal alloy), a plastic (e.g., polyethylene terephthalate, high-density polyethylene, low-density polyethylene, polypropylene, polycarbonate, and/or any other suitable plastics), and/or any other suitable material.

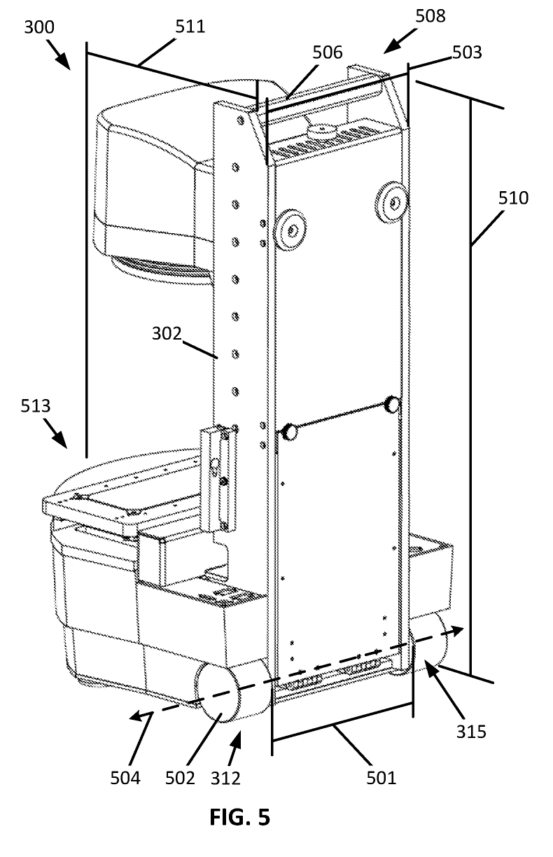

As shown in FIG. 5, the rocker 312 includes a plurality of cylindrical bodies 502 positioned along a transverse axis 504 that extends through opposing sides of the chassis 302. In some instances, the cylindrical bodies 502 are positioned adjacent opposing sides of the chassis 302 and/or the measurement system 300. For example, in some instances, a measure of a separation distance 501 between opposing surfaces of the cylindrical bodies 502 may be substantially equal (e.g., less than a 10% difference, less than a 5% difference, or less than a 1% difference) to a measure of a chassis width 503 taken along the transverse axis 504. Therefore, a measure of the separation distance 501 and/or the chassis width 503 may be, for example, in a range of 15 centimeters (cm) to 75 cm. By way of further example, a measure of the separation distance 501 and/or the chassis width 503 may be, for example, in a range of 20 cm to 35 cm.

Each cylindrical body 502 may be rotatably coupled to the chassis 302 such that, when the measurement system 300 is reclined (or pivoted), the measurement system 300 may be transported using the cylindrical bodies 502. In other words, the cylindrical bodies 502 may function as a wheel. In these instances, the cylindrical bodies 502 may be lockable such that the cylindrical bodies 502 are selectively rotatable. Alternatively, the cylindrical bodies 502 may be non-rotatably coupled to the chassis 302. In some instances, the cylindrical bodies 502 may be integrally formed from the chassis 302.

While the rocker 312 is generally shown as including a plurality of cylindrical bodies 502, such a configuration is non-limiting. For example, the rocker 312 may be a single unitary body that extends along the transverse axis 504. In some instances, the rocker 312 is not cylindrical in shape. For example, the rocker 312 may have a cross-section (e.g., as taken perpendicular to the transverse axis 504) that is octagonal, pentagonal, elliptical, square, rectangular, triangular, and/or any other shape.

The measurement system 300 may also include a handle 506. The handle 506 may allow an operator of the measurement system 300 to more easily transition the measurement system 300 between the first and second positions. As shown, the handle 506 is coupled to the chassis 302 at a distal end 508 of the measurement system 300. For example, a measure of a separation distance 510 between the handle 506 and the peripheral surface 315 of the rocker 312 may be maximized.

A measure of the separation distance 510 may be, for example, in a range of 50 cm to 100 cm. By way of further example, a measure of the separation distance 510 may be in a range of 65 cm to 85 cm. By way of even further example, a measure of the separation distance 510 may be in a range of 70 cm to 80 cm. A measure of a separation distance 511 between the handle 506 and a forward portion 513 of the measurement system 300 may measure, for example, in a range of 15 cm to 80 cm. By way of further example, a measure of the separation distance 511 may be in a range of 25 cm to 50 cm.

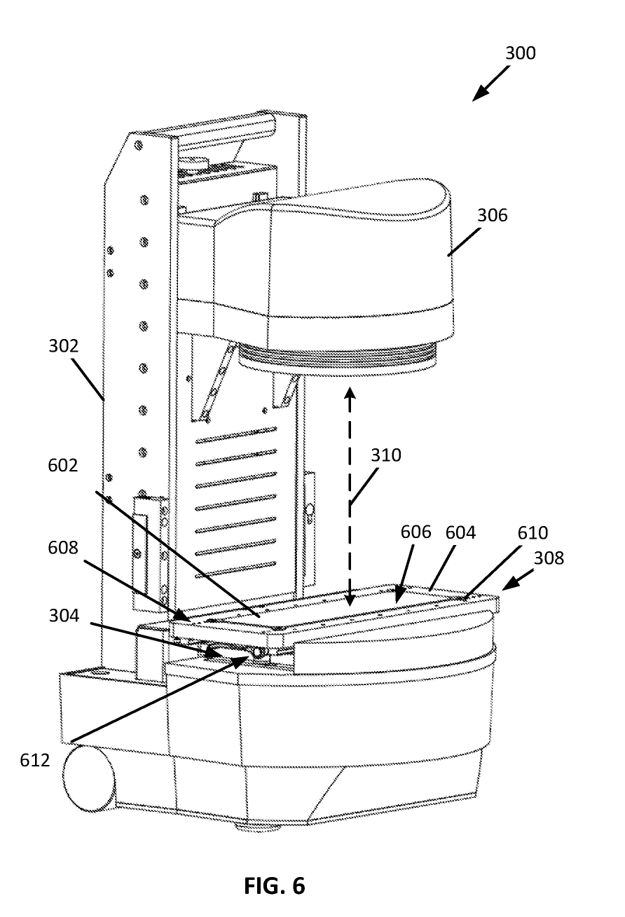

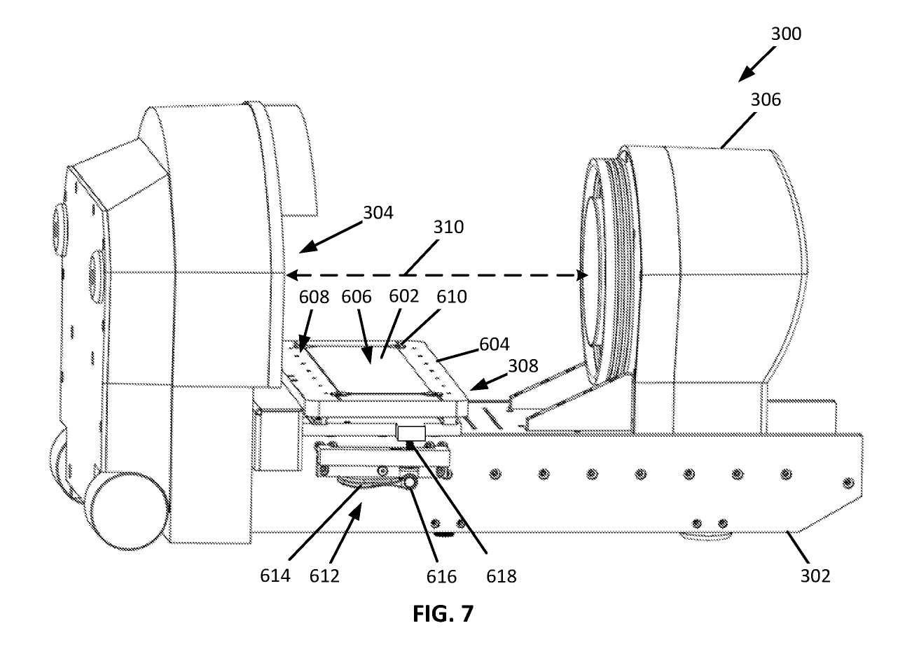

FIG. 6 shows a perspective view of the measurement system 300 in the first position having the table 308 in a first orientation and FIG. 7 shows a perspective view of the measurement system 300 in the second position having the table 308 in a second orientation. The table 308 may be transitioned between the first and second orientations in response to the measurement system 300 being transitioned between the first position (as shown in FIG. 6) and the second position (as shown in FIG. 7). When the table 308 is in either the first orientation or the second orientation, the table 308 may remain in the depth of field of the digital imaging system 306.

As shown in FIG. 6, when the table 308 is in the first orientation, the table 308 at least partially occludes (e.g., covers or obscures) the light source 304. In other words, the optical axis 310 intersects the table 308. In some instances, at least a portion of the table 308 is at least partially transparent. For example, the table 308 may include an at least partially transparent portion 602 for allowing light generated by the light source 304 to pass through the table 308. In these instances, the optical axis 310 intersects (e.g., extends through) the at least partially transparent portion 602.

The at least partially transparent portion 602 may be, for example, at least 50% transparent (i.e., at least 50% of the light incident on the at least partially transparent portion 602 passes through), at least 60% transparent, at least 70% transparent, at least 80% transparent, at least 90% transparent, or any other suitable transparency. In some instances, the at least partially transparent portion 602 may be polarized. The at least partially transparent portion 602 may include and/or be formed from, for example, polycarbonate, poly(methyl methacrylate), borosilicate glass, aluminum oxynitride, and/or any other suitable material.

As shown, the at least partially transparent portion 602 is coupled to a frame 604 such that the frame 604 and the at least partially transparent portion 602 collectively form the table 308. In some instances, the at least partially transparent portion 602 may be at least partially recessed within the frame 604. For example, a supporting surface 606 of the at least partially transparent portion 602 may be substantially co-planar (e.g., within manufacturing tolerances) with a supporting surface 608 of the frame 604.

In some instances, the supporting surface 606 of the at least partially transparent portion 602 may have a surface area in a range of, for example, 75 cm² to 250 cm². By way of further example, the supporting surface 606 of the at least partially transparent portion 602 may have a surface area in a range of 100 cm² to 175 cm². By way of even further example, the supporting surface 606 of the at least partially transparent portion 602 may have a surface area in a range of 110 cm² to 155 cm².

The at least partially transparent portion 602 may be removably coupled to the frame 604 using, for example, one or more removable clips 610. As shown, the removable clips 610 are coupled to the frame 604 such that the removable clips 610 engage (e.g., contact) the at least partially transparent portion 602. In some instances, the removable clips 610 may be at least partially recessed within the frame 604. For example, a surface of the removable clips 610 may be substantially co-planar (e.g., within manufacturing tolerances) with the supporting surface 608 of the frame 604. Alternatively, the at least partially transparent portion 602 may be non-removably coupled to the frame 604 using, for example, an adhesive.

When transitioning the measurement system 300 between the first position (e.g., as shown in FIG. 6) and the second position (e.g., as shown in FIG. 7), the table 308 may be decoupled from the measurement system 300 such that the orientation of the table 308 may be changed. As shown in FIG. 6, when the table 308 is in the first orientation, the at least partially transparent portion 602 of the table 308 occludes the light source 304 such that the optical axis 310 extends through the at least partially transparent portion 602. As shown in FIG. 7, when the table 308 is in the second orientation, the table 308 does not occlude the light source 304. When not occluding the light source 304, the table 308 may be spaced apart from the optical axis 310. For example, the supporting surface 606 of the at least partially transparent portion 602 and the supporting surface 608 of the frame 604 (which may be generally referred to as a supporting surface of the table 308) may be substantially parallel with the optical axis 310. In some instances, the table 308 is positioned between the optical axis 310 and at least a portion of the chassis 302 such that the table 308 does not intersect the optical axis 310.

The table 308 may be decoupled from the measurement system 300 by actuating a release assembly 612. The release assembly 612 may include a threaded portion that threadably engages, for example, the table 308 or the chassis 302. In some instances, the release assembly 612 includes a lever arm 614, a cam region 616, and an at least partially threaded shaft 618, wherein an application of a force on the lever arm 614 results in a tension force being applied to (or removed from) the at least partially threaded shaft 618. However, the release assembly 612 is not limited to such a configuration. For example, the release assembly 612 may include a latch, a clamp, magnets, and/or any other suitable mechanism for releasably coupling the table 308 to the measurement system 300.

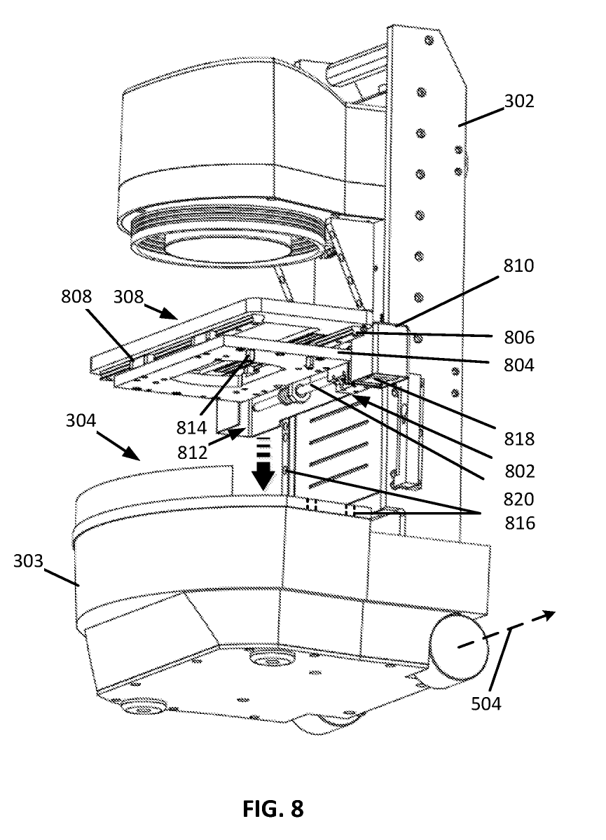

FIG. 8 shows the table 308 being decoupled from the measurement system 300. As shown, the table 308 is coupled to a table driver 802, a base 804, one or more table rails 806, and one or more guides 808 that slideably engage the table rails 806. In some instances, a housing 810 at least partially encloses the table driver 802. For example, as shown, the housing 810 defines a cavity 812 having an open end for receiving the table driver 802. The open end of the cavity 812 may be at least partially obscured (e.g., covered) by, for example, the chassis 302 and/or the enclosure 303. As shown, when changing the orientation of the table 308, the orientation of the table driver 802, the base 804, the table rails 806, and/or the guides 808 may also be changed to correspond to the orientation of the table 308.

When actuated, the table driver 802 may cause the table 308 to move relative to the light source 304. For example, the table rails 806 may move (e.g., slide) relative to the guides 808. In some instances, the table driver 802 causes the table 308 to move in a direction parallel to the transverse axis 504. Additionally (or alternatively), the table driver 802 may cause the table 308 to move in a direction transverse to the transverse axis 504. The table driver 802 may be coupled to the table 308 using one or more of, for example, a threaded fastener (e.g., a bolt or a screw), an adhesive, a press-fit, a snap-fit, one or more welds, a rivet, and/or any other suitable form of coupling.

The table driver 802 may include a motor 818 and a drive shaft 820. The drive shaft 820 may be rotatably coupled to the table 308 such that a rotation of the drive shaft 820 urges the table 308 in a direction that is, for example, parallel to the transverse axis 504. In some instances, the drive shaft 820 is threaded (e.g., the drive shaft 820 may be a worm gear) such that the drive shaft 820 threadably engages a portion of the table 308. As such, rotation of the drive shaft 820 will result in a movement of the table 308. The motor 818 may be, for example, a stepper motor, a servomotor, a brushless DC motor, a brushed DC motor, and/or any other suitable motor. While the table driver 802 is shown as having the motor 818 and the drive shaft 820, such a configuration is non-limiting. For example, the table driver 802 may include a hydraulic system, a belt/chain drive system, a pneumatic system, a rack and pinion system, and/or any other suitable system. In some instances, the table driver 802 may be manually operated.

The table rails 806 may be coupled to the table 308 (e.g., to the frame 604) and the guides 808 may be coupled to the base 804. In other instances, the table rails 806 may be coupled to the base 804 and the guides 808 may be coupled to the table 308 (e.g., the frame 604). By way of further example, a first table rail 806 and a first guide 808 may be coupled to the table 308 and a second table rail 806 that corresponds to the first guide 808 and a second guide 808 that corresponds to the first table rail 806 may be coupled to the base 804. In other words, the table rails 806 and the guides 808 may be coupled to a respective one of the table 308 or the base 804 such that each guide 808 is opposite a respective table rail 806.

The base 804 may include one or more alignment pins 814 extending from the base 804 in a direction away from the table 308. The alignment pins 814 may correspond to alignment sockets 816 provided in the measurement system 300 (e.g., in the chassis 302). In some instances, the alignment pins 814 slideably engage an inner surface of a corresponding alignment socket 816 such that movement of the alignment pins 814 is substantially restricted to a single axis when positioned within the alignment sockets 816. The alignment pins 814 may have a circular cross-section, a square cross-section, an octagonal cross-section, a pentagonal cross-section, and/or any other suitable cross-section. In some instances, there may be a plurality of alignment pins 814, wherein at least one alignment pin 814 has a cross-sectional shape that is different from at least one other alignment pin 814.

When changing the orientation of the table 308, the alignment pins 814 may allow an operator of the measurement system 300 to more easily reorient the table 308. For example, one or more wires (e.g., to control/power the table driver 802) may need to be disconnected and reconnected and/or one or more data/power contacts (e.g., to control/power the table driver 802) may need to be realigned with corresponding data/power contacts coupled to the measurement system 300 in response to reorienting the table 308. By way of further example, the alignment pins 814 may also align features that interact with release assembly 612. As such, the alignment pins 814 may make the process of reconnecting the table 308 to the measurement system 300 more efficient and/or easier for the operator.

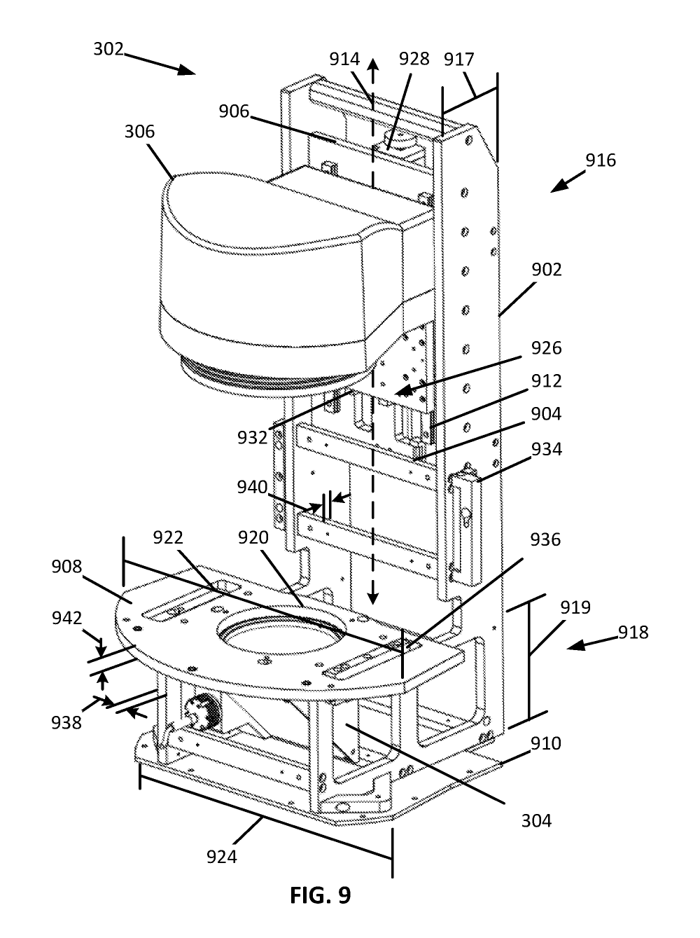

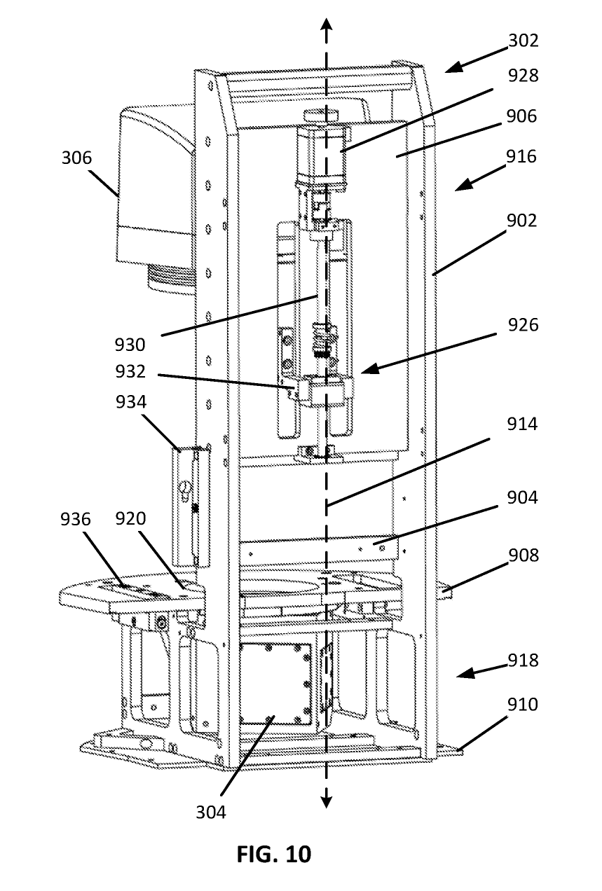

As shown in FIGS. 9 and 10, the chassis 302 includes a plurality of sides 902, one or more supports 904 extending between the plurality of sides 902, an imaging system mount 906, a platform 908, and a chassis base 910. Each side 902 may include a first region 916 that is adjacent the digital imaging system 306 and a second region 918 extending from the first region 916 that is adjacent the light source 304. In other words, the sides 902 and/or the chassis 302 may generally be described as “L-shaped.” The first region 916 may have a first region width 917 and the second region 918 may have a second region width 919. When assembled, the first region 916 of each side 902 may support the digital imaging system 306 such that the digital imaging system 306 is opposite the light source 304 and the second regions 918 may at least partially define a bounded volume for receiving at least a portion of the light source 304.

The first region width 917 may measure, for example, in a range of 2 cm to 20 cm and the second region width 919 may measure, for example, in a range of 5 cm to 35 cm. By way of further example, the first region width 917 may measure in a range of 5 cm to 15 cm and the second region width 919 may measure in a range of 10 cm to 20 cm. By way of even further example, a ratio of the first region width 917 to a side thickness 938 may be in range of 5:1 to 10:1. By way of further example, a ratio of the first region width 917 to the side thickness 938 may be in range of 7:1 to 8:1. The side thickness 938 may measure, for example, in a range of 0.6 cm to 2.54 cm. By way of further example, the side thickness 938 may measure, for example, in a range of 1 cm to 1.5 cm.

Each side 902 may be coupled to the other using, for example, the supports 904, the platform 908, and/or the chassis base 910. As shown, the chassis base 910 is coupled to the sides 902 at the second region 918 such that the light source 304 is positioned between the chassis base 910 and the platform 908. In other words, the chassis base 910 may generally be described as being positioned at a distal most end of the chassis 302. The platform 908 may be coupled to the second region 918 of the sides 902 such that the platform 908 is positioned between the table 308 (FIGS. 3 and 4) and the light source 304. As such, the table 308 may couple to the platform 908. As shown, the platform 908 may include an aperture 920 extending therethrough to allow light generated by the light source 304 to pass through the platform 908.

A platform width 922 and/or a base width 924 may measure greater than the chassis width 503. In some instances, for example, the platform width 922 and/or the base width 924 may measure in a range of 20 cm to 100 cm. By way of further example, the platform width 922 and/or the base width 924 may measure in a range of 30 cm to 50 cm. In some instances, the base width 924 may measure less than the platform width 922.

The rigidity of the chassis 302 may be increased when one or more of the sides 902, the supports 904, the chassis base 910, and the platform 908 are unitary structures. For example, each side 902 may be formed from a single piece of material such that each side is a unitary structure. Therefore, each of the sides 902, the supports 904, the chassis base 910, and the platform 908 may be formed by one or more of casting, machining (e.g., milled, laser cut, plasma cut, water jet cut, and/or any other suitable form of machining) from a single piece of stock, and/or any other method of making a unitary structure. Increasing the rigidity of the chassis 302 may decrease the amount of flex (e.g., deflection) experienced by the chassis 302 when transitioning the chassis 302 between the first and second positions. Decreasing the amount of flex may, for example, reduce or otherwise prevent the misalignment of the digital imaging system 306 relative to, for example, the table 308 that may be caused by the transition between the first and second positions.

The one or more supports may have a support thickness 940 and the platform 908 may have a platform thickness 942. The support thickness 940 may, for example, measure in a range of 0.6 cm to 2.54 cm and the platform thickness 942 may, for example, measure in a range of 0.6 cm to 2.54 cm. By way of further example, the support thickness 940 may measure in a range of 1 cm to 1.5 cm and the platform thickness 942 may measure in a range of 1 cm to 1.5 cm. In some instances, the side thickness 938, the support thickness 940, and the platform thickness 942 may each measure the same.

The sides 902, the supports 904, the chassis base 910, and the platform 908 may be formed of any suitable material. For example, the sides 902, the supports 904, the chassis base 910, and the platform 908 may be formed of one or more of a metal (e.g., an aluminum alloy, a stainless steel alloy, a titanium alloy, and/or any other suitable metal or metal alloy), a composite material (e.g., a carbon fiber composite material and/or any other suitable composite material), and/or any other suitable material.

As shown, the chassis 302 includes a plurality of mounts 934 for receiving and/or coupling to at least a portion of the release assembly 612 (FIG. 6). Each mount 934 may be coupled to and/or integrally formed from a respective one of the sides 902. In some instances, each side 902 may have a respective mount 934. As also shown, the chassis 302 may include a plurality of alignment blocks 936 that include one or more of the alignment sockets 816. The alignment blocks 936 may be coupled to and/or integrally formed from a respective one of the sides 902. In some instances, each side 902 may have a respective alignment block 936. Each mount 934 and each alignment block 936 may be coupled to the chassis 302 using one or more of a threaded fastener (e.g., a bolt or screw), a press-fit, a snap fit, an adhesive, one or more welds, a rivet, and/or any other suitable form of coupling.

The imaging system mount 906 may include one or more imaging system rails 912. The imaging system rails 912 may slideably engage a portion of the digital imaging system 306 such that a position of the digital imaging system 306 along a longitudinal axis 914 of the chassis 302 may be adjusted. A lift assembly 926 may be provided to adjust the longitudinal position of the digital imaging system 306.

As shown, the lift assembly 926 includes a motor 928 coupled to a drive shaft 930. The drive shaft 930 may be rotatably coupled to, for example, the digital imaging system 306 and/or a lift 932. The lift 932 may directly or indirectly engage the digital imaging system 306 such that the digital imaging system 306 is urged along the one or more imaging system rails 912. In some instances, the drive shaft 930 is threaded (e.g., the drive shaft 930 may be a worm gear) such that the drive shaft threadably engages with a portion of the digital imaging system 306 and/or the lift 932. As such, a rotation of the drive shaft 930 will result in the movement of the digital imaging system 306 in a direction parallel to the longitudinal axis 914. The motor 928 may be, for example, a stepper motor, a servomotor, a brushless DC motor, a brushed DC motor, and/or any other suitable motor. While the lift assembly 926 is shown as having the motor 928 and the drive shaft 930, such a configuration is non-limiting. For example, the lift assembly 926 may include a hydraulic system, a belt/chain drive system, a pneumatic system, a rack and pinion system, and/or any other suitable system. In some instances, the lift assembly 926 may be manually operated.

According to one aspect of the present disclosure, there is provided a digital optical video measurement system. The digital optical video measurement system may include a chassis, a digital imaging system coupled to the chassis, and a light source coupled to the chassis. The light source may be configured to emit light along an optical axis extending in a direction of the digital imaging system. The digital optical video measurement system may also include a table coupled to the chassis. The table may have a first orientation and a second orientation. When the table is in the first orientation, the optical axis may intersect the table. When the table is in the second orientation, the optical axis may be spaced apart from the table.

According to another aspect of the present disclosure, there is provided a digital optical video measurement system. The digital optical video measurement system may include a chassis, a digital imaging system coupled to the chassis, and a light source opposite the digital imaging system and coupled to the chassis. The light source may be configured to emit light along an optical axis that extends in a direction of the digital imaging system. The digital optical video measurement system may also include a rocker coupled to the chassis. The chassis may transition between a first position and a second position in response to being pivoted on the rocker.

According to yet another aspect of the present disclosure, there is provided a digital optical video measurement system. The digital optical video measurement system may include a chassis having a plurality of sides. Each of the plurality of sides may be a unitary structure. The chassis may transition between a first position and a second position in response to being pivoted. The digital optical video measurement system may also include a digital imaging system coupled to the chassis and a light source opposite the digital imaging system and coupled to the chassis. The light source may be configured to emit light along an optical axis that extends in a direction of the digital imaging system.

While several embodiments of the present disclosure have been described and illustrated herein, those of ordinary skill in the art will readily envision a variety of other means and/or structures for performing the functions and/or obtaining the results and/or one or more of the advantages described herein, and each of such variations and/or modifications is deemed to be within the scope of the present disclosure. More generally, those skilled in the art will readily appreciate that all parameters, dimensions, materials, and configurations described herein are meant to be exemplary and that the actual parameters, dimensions, materials, and/or configurations will depend upon the specific application or applications for which the teachings of the present disclosure is/are used.

Those skilled in the art will recognize, or be able to ascertain using no more than routine experimentation, many equivalents to the specific embodiments of the disclosure described herein. It is, therefore, to be understood that the foregoing embodiments are presented by way of example only and that, within the scope of the appended claims and equivalents thereto, the disclosure may be practiced otherwise than as specifically described and claimed. The present disclosure is directed to each individual feature, system, article, material, kit, and/or method described herein. In addition, any combination of two or more such features, systems, articles, materials, kits, and/or methods, if such features, systems, articles, materials, kits, and/or methods are not mutually inconsistent, is included within the scope of the present disclosure.

All definitions, as defined and used herein, should be understood to control over dictionary definitions, definitions in documents incorporated by reference, and/or ordinary meanings of the defined terms.

The indefinite articles “a” and “an,” as used herein in the specification and in the claims, unless clearly indicated to the contrary, should be understood to mean “at least one.”

The terms “couple” and “coupled,” as used herein, encompass both direct and indirect coupling unless clearly indicated to the contrary.

The phrase “and/or,” as used herein in the specification and in the claims, should be understood to mean “either or both” of the elements so conjoined, i.e., elements that are conjunctively present in some cases and disjunctively present in other cases. Other elements may optionally be present other than the elements specifically identified by the “and/or” clause, whether related or unrelated to those elements specifically identified, unless clearly indicated to the contrary.

What is claimed is:

1. A digital optical video measurement system comprising:
a chassis;
a digital imaging system coupled to the chassis;
a light source coupled to the chassis and configured to emit light along an optical axis, the optical axis extending in a direction of the digital imaging system; and
a table coupled to the chassis, the table having a first orientation and a second orientation, wherein, when the table is in the first orientation, the optical axis intersects the table and, when the table is in the second orientation, the optical axis is spaced apart from the table.

2. The digital optical video measurement system of claim 1, wherein the table further comprises a frame and an at least partially transparent portion coupled to the frame.

3. The digital optical video measurement system of claim 2, wherein, when the table is in the first orientation, the optical axis intersects the at least partially transparent portion.

4. The digital optical video measurement system of claim 1, further comprising a table driver, the table driver causing the table to move relative to the light source.

5. The digital optical video measurement system of claim 1, wherein the chassis includes a plurality of sides, each of the plurality of sides being a unitary structure.

6. The digital optical video measurement system of claim 5, further comprising a rocker coupled to the chassis, wherein the digital optical video measurement system transitions between a first position and a second position in response to pivoting on the rocker.

7. The digital optical video measurement system of claim 6, wherein, when the digital optical video measurement system is in the first position, the table is in the first orientation and, when the digital optical video measurement system is in the second position, the table is in the second orientation.

8. The digital optical video measurement system of claim 6, wherein the digital optical video measurement system rotates through a rotation angle of approximately 90° in response to transitioning between the first position and the second position.

9. A digital optical video measurement system comprising:
a chassis;
a digital imaging system coupled to the chassis;
a light source opposite the digital imaging system and coupled to the chassis, the light source being configured to emit light along an optical axis that extends in a direction of the digital imaging system; and
a rocker coupled to the chassis, wherein the chassis transitions between a first position and a second position in response to being pivoted on the rocker.

10. The digital optical video measurement system of claim 9 further comprising a table having a first orientation and a second orientation, wherein, when the table is in the first orientation, the optical axis intersects the table and, when the table is in the second orientation, the optical axis is spaced apart from the table.

11. The digital optical video measurement system of claim 10, wherein, when the chassis is in the first position, the table is in the first orientation and, when the chassis is in the second position, the table is in the second orientation.

12. The digital optical video measurement system of claim 11, further comprising a table driver, the table driver causing the table to move relative to the light source.

13. The digital optical video measurement system of claim 10, wherein the table further comprises a frame and an at least partially transparent portion coupled to the frame, the optical axis intersecting the at least partially transparent portion when the table is in the first orientation.

14. The digital optical video measurement system of claim 9, wherein the chassis includes a plurality of sides, each of the plurality of sides being a unitary structure.

15. A digital optical video measurement system comprising:
a chassis having a plurality of sides, each of the plurality of sides being a unitary structure, wherein the chassis transitions between a first position and a second position in response to being pivoted;
a digital imaging system coupled to the chassis; and
a light source opposite the digital imaging system and coupled to the chassis, the light source being configured to emit light along an optical axis that extends in a direction of the digital imaging system.

16. The digital optical video measurement system of claim 15 further comprising a table having a first orientation and a second orientation, wherein, when the table is in the first orientation, the optical axis intersects the table and, when the table is in the second orientation, the optical axis is spaced apart from the table.

17. The digital optical video measurement system of claim 16, wherein, when the chassis is in the first position, the table is in the first orientation and, when the chassis is in the second position, the table is in the second orientation.

18. The digital optical video measurement system of claim 17, further comprising a table driver, the table driver causing the table to move relative to the light source.

19. The digital optical video measurement system of claim 16, wherein the table further comprises a frame and an at least partially transparent portion coupled to the frame, the optical axis intersecting the at least partially transparent portion when the table is in the first orientation.

20. The digital optical video measurement system of claim 15, further comprising a rocker coupled to the chassis, wherein the chassis pivots on the rocker.
